(19) United States
(12) Patent Application Publication
(10) Pub. No.: US 2019/0299465 A1
(43) Pub. Date: Oct. 3, 2019

(54) HEATED SHAVING RAZOR

(71) Applicant: The Gillette Company LLC, Boston, MA (US)

(72) Inventors: Matthias Gester, Farnborough (GB); Thomas Alva Baer, Rockland, MA (US); Ashok Bakul Patel, Needham, MA (US); Stephanie Brown, Boston, MA (US)

(21) Appl. No.: 16/357,525

(22) Filed: Mar. 19, 2019

Related U.S. Application Data
(60) Provisional application No. 62/650,365, filed on Mar. 30, 2018.

(51) Int. Cl. B26B 21/48; B26B 21/52; B26B 21/40

(52) U.S. Cl. CPC B26B 21/48; B26B 21/4012; B26B 21/521

(57) ABSTRACT

A shaving razor system with a handle having an elongated gripping portion with a proximal end portion and a distal end portion. A heat delivering element is mounted to the proximal end portion of the handle. The heat delivering element has a skin contacting surface. The heat delivering element is able to increase the temperature of the skin contacting surface from an initial temperature in air of 25° C. to an elevated temperature in air of 43° C. in less than 5 seconds. A power source is positioned within the handle and is in electrical communication with the heat delivering element. The power source has a power from 4 Watts to 8 Watts. A removable shaving razor cartridge mounted to the proximal end of the handle.

### FIELD OF THE INVENTION

The present invention relates to shaving razors and razor cartridges, and more particularly to heated shaving razors for wet shaving.

### BACKGROUND OF THE INVENTION

Users of wet-shave razors generally appreciate a feeling of warmth against their skin during shaving. The warmth feels good, resulting in a more comfortable shave. For example, barbershops typically wrap the client's face in a warm towel and apply heated shaving cream to the face prior to shaving. Various attempts have been made to provide products that deliver a warm feeling during the shaving process. For example, shaving creams have been formulated to react exothermically upon release from the shaving canister, so that the shaving cream imparts warmth to the skin. Also, razor heads have been heated using hot air, heating elements, and linearly scanned laser beams, with power being supplied by a power source such as a battery. Razor blades within a razor cartridge have also been heated. The drawback with heated blades is they have minimal surface area in contact with the user's skin. This minimal skin contact area provides a relatively inefficient mechanism for heating the user's skin during shaving.

One of the inherent problems with heated razors is the slow heat up time of the heating element or blade. As the user shaves the heated razor comes into contact with skin, air and water. Skin, air and water act as heat sinks taking the thermal energy from the heating element of the razor causing the heating element to cool. If the heat up time of the razor is too slow the razor is not able to heat to the desired temperature prior to the user taking the next shaving stroke after coming into contact with air, water or skin. As the user then brings the razor into contact with the skin on the next shaving stroke the user is expecting the razor to be warm. Instead the user brings a cool razor into contact with the skin and experiences a less than satisfactory cool shave. There is a need to provide a razor capable of delivering rapid heat up to the user during shaving while working within the confines of conventional rechargeable power sources.

### SUMMARY OF THE INVENTION

In one aspect, the invention features, in general, an efficient shaving razor system having a handle with an elongated gripping portion with a proximal end portion and a distal end portion. The system includes a heat delivering element mounted to the proximal end portion of the handle. The heat delivering element comprises a skin contacting surface. The heat delivering element is able to increase the temperature of the skin contacting surface from an initial temperature in air of 25° C. to an elevated temperature in air of 43° C. in less than 5 seconds. A power source positioned within the handle. The power source is in electrical communication with the heat delivering element and has a power from about 4 Watts to about 8 Watts. A removable shaving razor cartridge is mounted to the proximal end of the handle. The removable shaving razor cartridge has a housing with a guard, a cap and at least one blade mounted to the housing between the guard and the cap.

The heat delivering element while submerged in water at 35° C. is able to increase the temperature of the skin contacting surface from an initial temperature of 35° C. to an elevated temperature of 43° C. in less than 5 seconds.

The heat delivering element has a thermal mass of from about 0.08 J/° C. to about 0.50 J/° C.

The heat delivering element has a mean conductivity of from about 0.10 W/cm-° C. to about 0.60 W/cm-° C.

The heat delivering element has a nominal heat up rate greater than 12° C./second. The heat delivering element preferably has a nominal heat up rate greater than about 30° C./second.

The heat delivering element has a nominal temperature drop of less than 2.0° C.

The heat delivering element has a heat conducting distance from about 0.02 cm to about 0.2 cm.

The removable shaving razor cartridge may be pivotably mounted to the proximal end portion of the handle.

The guard may comprise an elastomeric material.

The removable shaving razor cartridge defines an opening dimensioned to receive the heat delivering element.

The heat delivering element has an elongated portion extending generally parallel to the blade.

The heat delivering element may comprise a heat generator that defines a heating element top surface, one or more components between the heating element and the skin contacting surface, or a combination thereof.

### DETAILED DESCRIPTION OF THE DRAWINGS

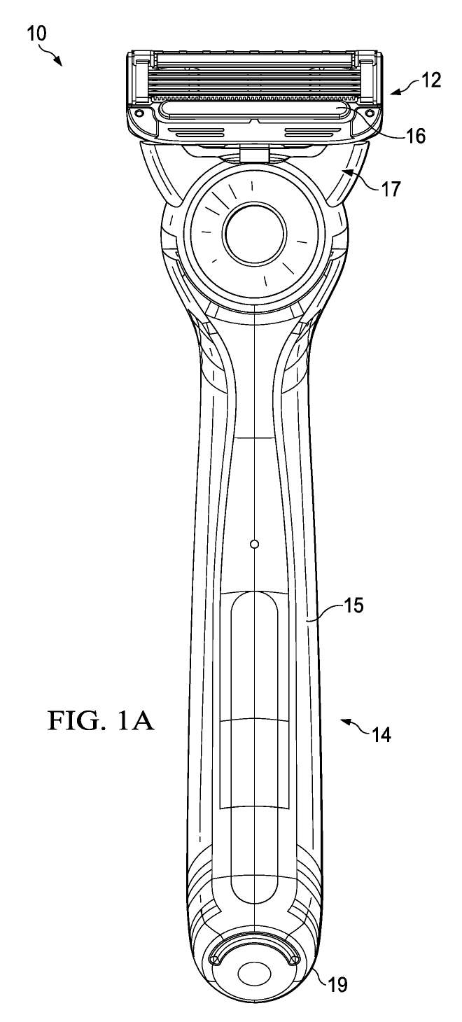

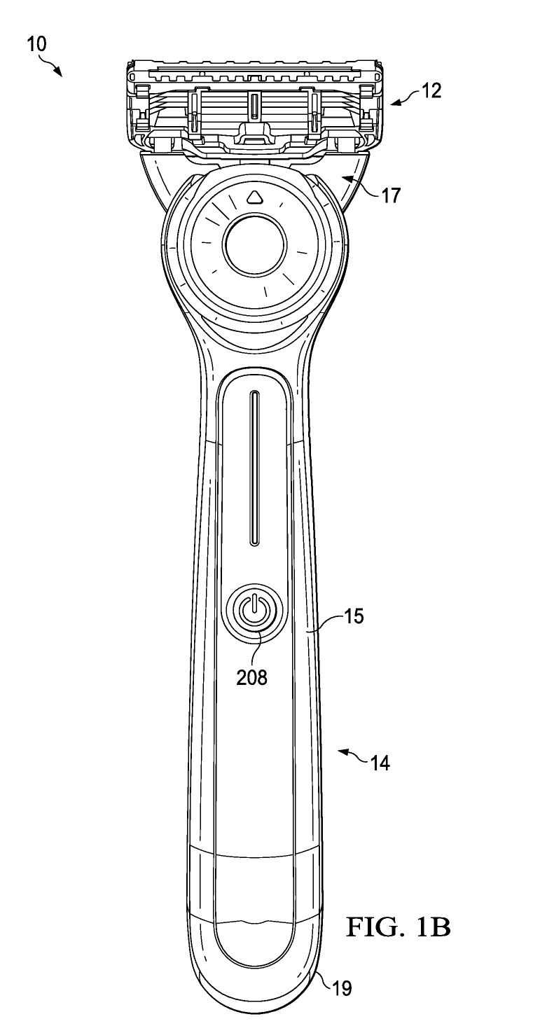

FIGS. 1A-1B are perspective views of a shaving razor system.

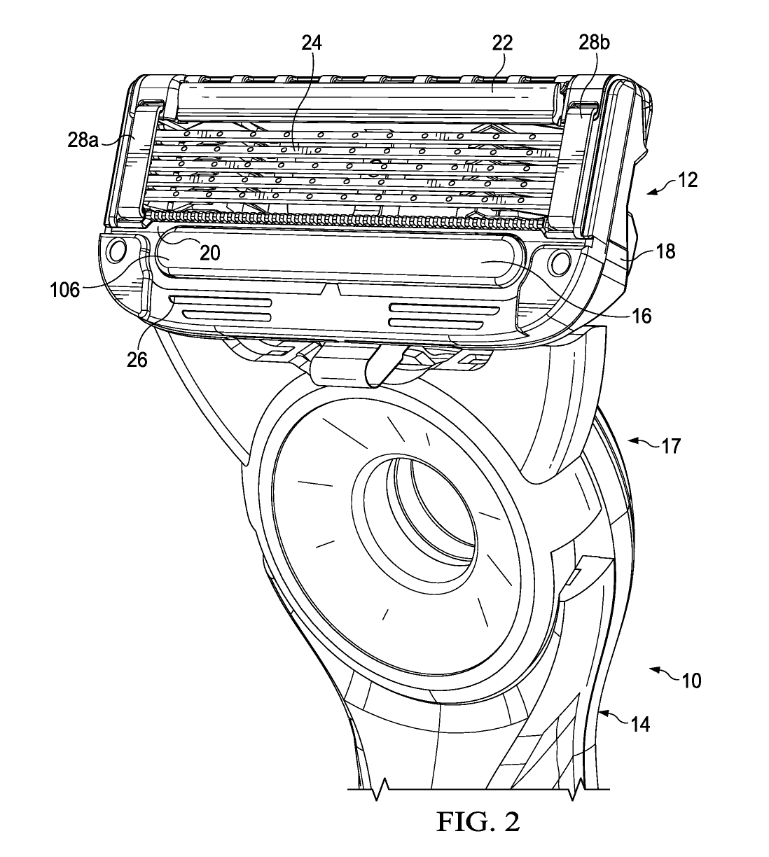

FIG. 2 is an enlarged perspective view of a portion of the shaving razor system of FIGS. 1A-1B.

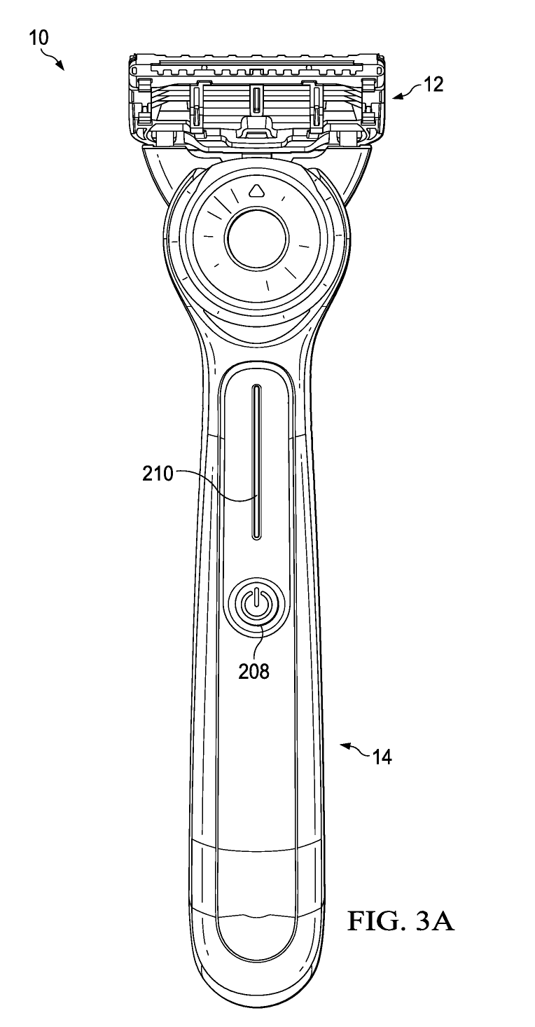

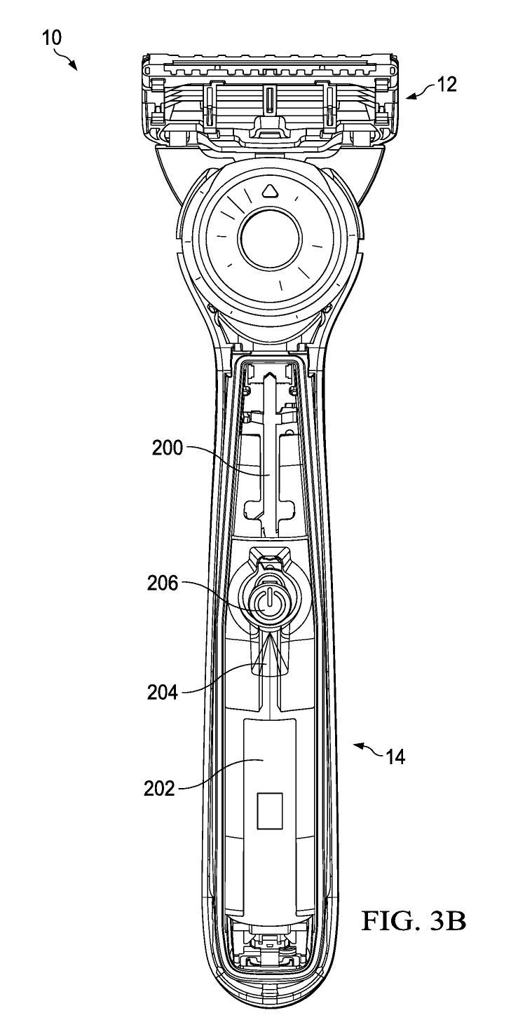

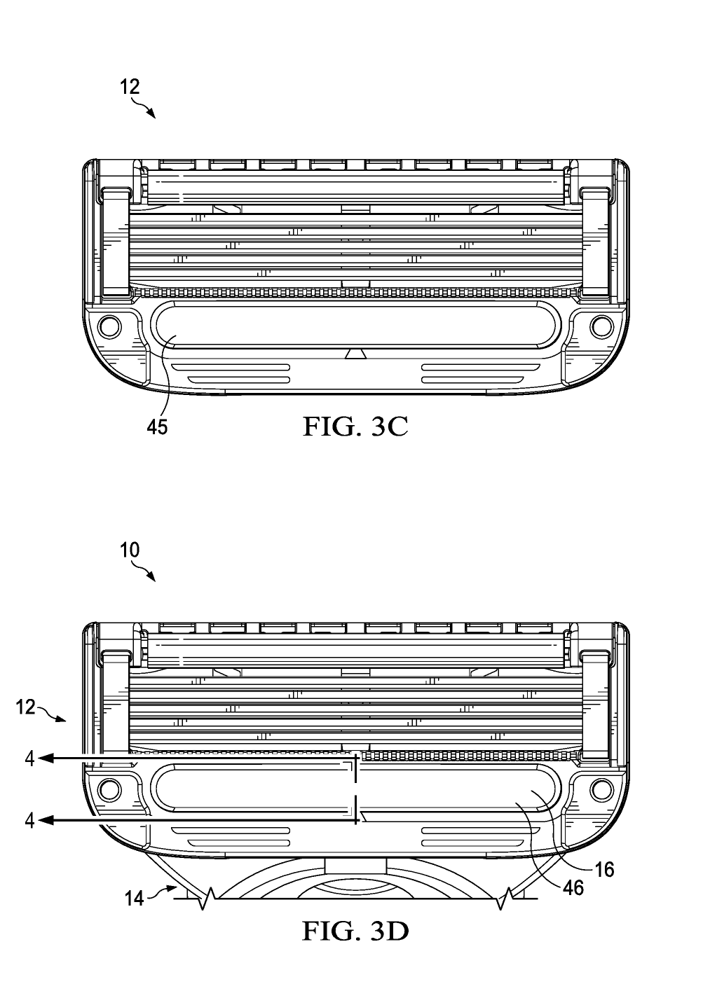

FIG. 3A is a perspective view of the shaving razor system.

FIG. 3B is a sectional view of the shaving razor system.

FIG. 3C is a perspective view of the razor cartridge of FIGS. 1A-1B.

FIG. 3D is a perspective view of the razor cartridge of FIGS. 1A-1B.

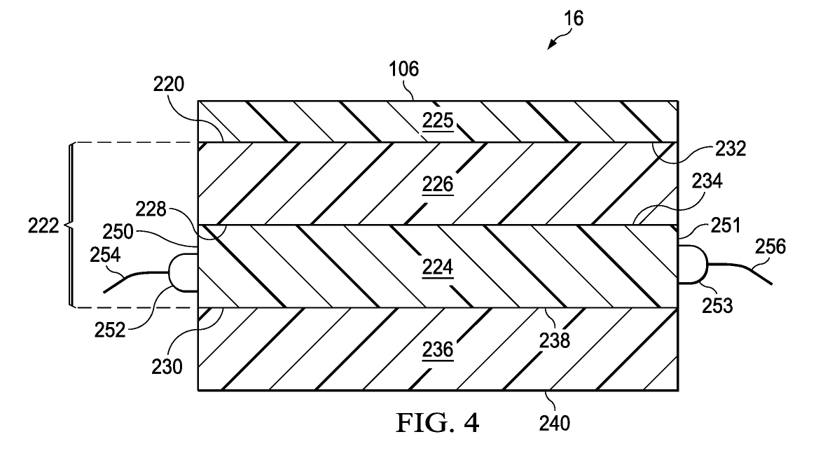

FIG. 4 is a cross-sectional view of the razor cartridge of a heat delivering element of the shaving razor system taken along line A-A of FIG. 3D.

FIG. 5 is a schematic view of an experimental test set-up in an air medium.

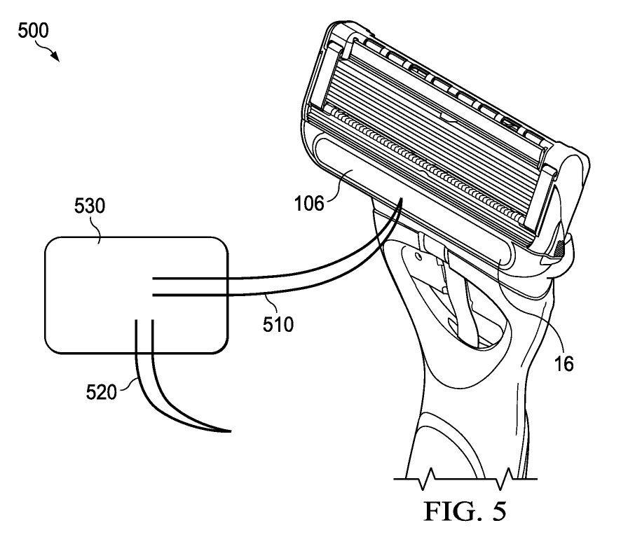

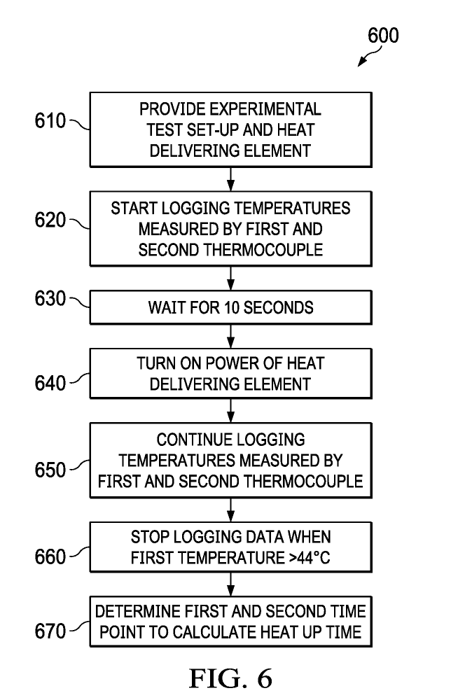

FIG. 6 is a schematic view of an experimental test protocol.

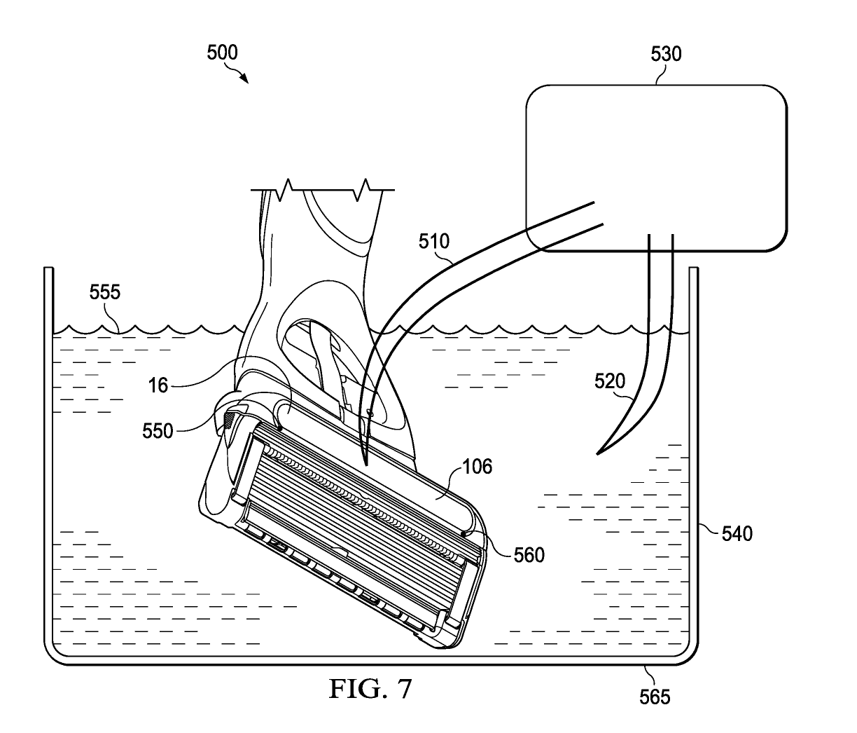

FIG. 7 is a schematic view of an experimental test set-up in a water medium.

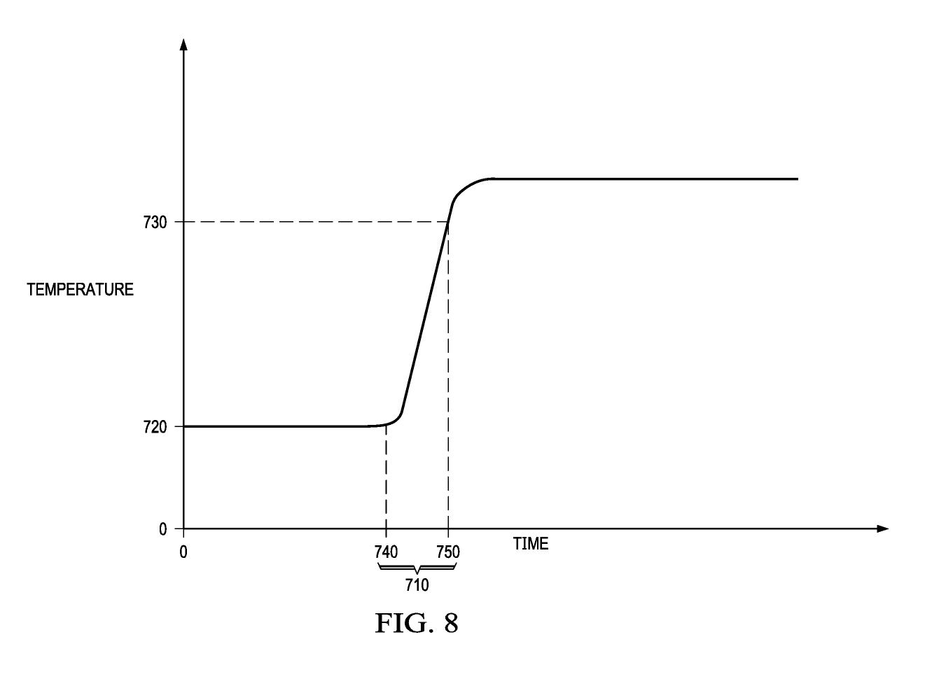

FIG. 8 is a graph depicting time and temperature of the experimental method.

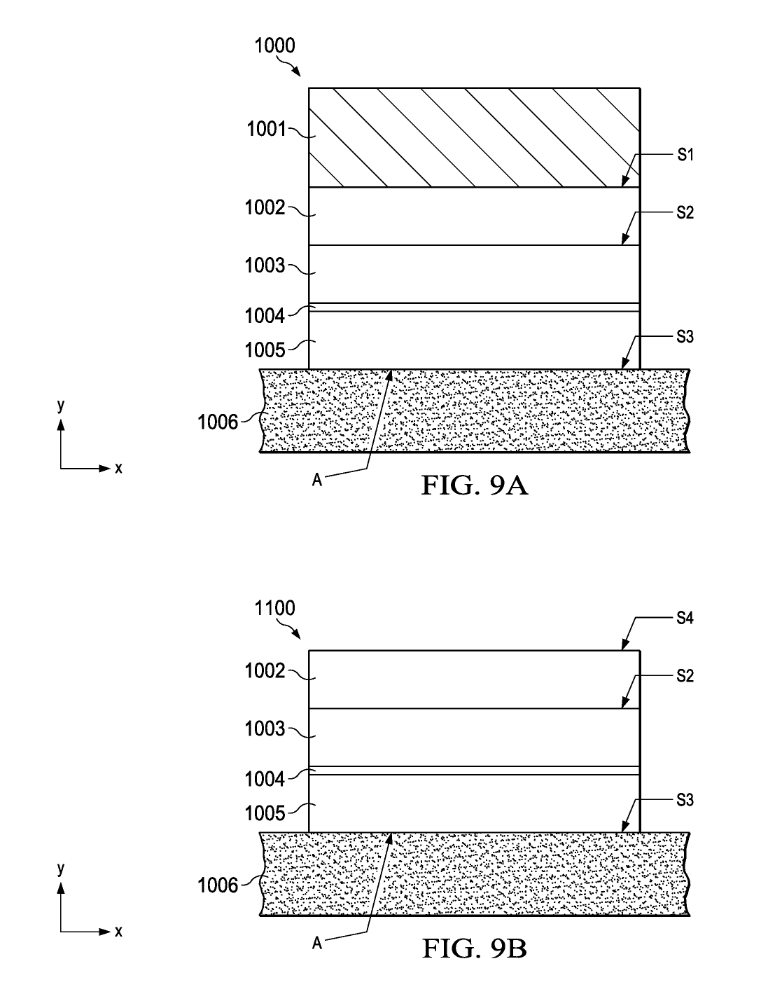

FIGS. 9A-9B are schematic views of heat delivering elements.

### DETAILED DESCRIPTION OF THE INVENTION

Referring to FIGS. 1A-2, an embodiment of the present disclosure is shown illustrating a shaving razor system 10. The shaving razor system includes a handle 14 having an elongated gripping portion 15, a proximal end 17 and a distal end 19. The shaving razor system 10 includes a shaving razor cartridge 12 mounted to the proximal end 17 of the handle 14. The shaving razor cartridge 12 may be fixedly or pivotably mounted to the handle 14, depending on the overall desired cost and performance of the shaving razor system 10. The handle 14 may hold a power source, such as one or more batteries (not shown) that supplies power to a heat delivering element 16.

The shaving razor cartridge 12 may be removably mounted to the handle 14, thus allowing the shaving razor cartridge 12 to be replaced. The shaving razor cartridge 12 has a housing 18 with a guard 20, a cap 22, and one or more blades 24 mounted to the housing 18 between the cap 22 and the guard 20. The guard 20 may be positioned toward a front portion of the housing 18 and the cap 22 may be positioned toward a rear portion of the housing 18 (i.e., the guard 20 is in front of the blades 24 and the cap is behind the blades 24). The guard 20 and the cap 22 may define a shaving plane that is tangent to the guard 20 and the cap 22. The guard 20 may be a solid or segmented bar that extends generally parallel to the blades 24. In certain embodiments, the guard 20 may comprise a skin-engaging member 26 (e.g., a plurality of fins, grooves or an elastomeric material) in front of the blades 24 for stretching the skin during a shaving stroke. The skin-engaging member 26 may be insert injection molded or co-injection molded to the housing 18. However, other known assembly methods may also be used such as adhesives, ultrasonic welding, or mechanical fasteners. The skin engaging member 26 may be molded from a softer material (i.e., lower durometer hardness) than the housing 18. For example, the skin engaging member 26 may have a Shore A hardness of about 20, 30, or 40 to about 50, 60, or 70. A softer material may enhance skin stretching, as well as provide a more pleasant tactile feel against the skin of the user during shaving. A softer material may also aid in masking the less pleasant feel of the harder material of the housing 18 and/or the fins against the skin of the user during shaving.

In certain embodiments, the blades 24 may be mounted to the housing 18 and secured by one or more clips 28a and 28b. Other assembly methods known to those skilled in the art may also be used to secure and/or mount the blades 24 to the housing 18 including, but not limited to, wire wrapping, cold forming, hot staking, insert molding, ultrasonic welding, and adhesives. The clips 28a and 28b may comprise a metal, such as aluminum for acting as a sacrificial anode to help prevent corrosion of the blades 24. Although five blades 24 are shown, the housing 18 may have more or fewer blades depending on the desired performance and cost of the shaving razor cartridge 12.

In certain embodiments, it may be desirable to provide heat in front of the blades 24. For example, the heat delivering element 16 may be positioned in front of the guard 20 and behind the skin engaging member 26. The heat delivering element 16 may comprise a skin contacting surface 106 that delivers heat to a user's skin during a shaving stroke for an improved shaving experience. As will be described in greater detail below, the heat delivering element 16 may be mounted to either the shaving razor cartridge 12 or to a portion of the handle 14, preferably the heat delivering element 16 is mounted to the proximal end portion 17 of the handle 14. As will be illustrated in greater detail below, the heat delivering element is in electrical communication with an electrical circuit.

The cap 22 may be a separate molded (e.g., a shaving aid filled reservoir) or extruded component (e.g., an extruded lubrication strip) that is mounted to the housing 18. In certain embodiments, the cap 22 may be a plastic or metal bar to aid in supporting the skin and define the shaving plane. The cap 22 may be molded or extruded from the same material as the housing 18 or may be molded or extruded from a more lubricious shaving aid composite that has one or more water-leachable shaving aid materials to provide increased comfort during shaving. The shaving aid composite may comprise a water-insoluble polymer and a skin-lubricating water-soluble polymer. Suitable water-insoluble polymers which may be used include, but are not limited to, polyethylene, polypropylene, polystyrene, butadiene-styrene copolymer (e.g., medium and high impact polystyrene), polyacetal, acrylonitrile-butadiene-styrene copolymer, ethylene vinyl acetate copolymer and blends such as polypropylene/polystyrene blend, may have a high impact polystyrene (i.e., Polystyrene-butadiene), such as Mobil 4324 (Mobil Corporation).

Referring to FIGS. 3A-3D, the heat delivering element 16 may be operably connected to a power source e.g., a rechargeable battery positioned within the handle 14 to provide a warming sensation during a shaving stroke. The handle 14 may have a switch 206 actuated by button 208 to control the operation of the heat delivering element 16. The shaving razor cartridge 12 defines an opening 45 dimensioned to receive the heat delivering element 16. The heat delivering element has an elongated portion 46 extending generally parallel to the blade 24 of FIG. 2.

The shaving razor system 10 may include an electrical circuit 200 to which current is supplied by a power source 202 (e.g., such as one or more disposable or rechargeable batteries) through a contact 204. The power source 202 has a power ranging from about 4 Watts to about 8 Watts. The power source 202 may be positioned within handle 14. The electrical circuit 200 is closed by a switch 206, which may be actuated by the user by pushing button 208. An LED 210 is provided on handle 14 to indicate to the user that the power has been turned on or off. The LED 210 may be disposed in a transparent area of the handle 14 or may extend through an opening in the handle 14. The LED 210 may be positioned in an area of the handle 14 other than that shown in FIG. 3, or may be omitted. The LED 210 may indicate whether the heat delivering element 16 is warm or warming, whether the heat delivering element 16 is too hot and other properties of the shaving razor system 10.

The heat delivering element 16 may comprise any material that is effective in dissipating heat. A suitable material for the heat delivering element 16 is a metal such as aluminum, copper, gold, steel, brass, nickel and alloys thereof with aluminum being the preferred metal. Other materials having heat dissipating properties similar to those of the metals listed may also be used. The heat delivering element 16 may be coated or textured to provide an improved user experience as it may come into direct contact with the user's skin during shaving. For example, the heat delivering element 16 may be textured with small protuberances or bumps and coated with a polymer composition such as a polyfluorocarbon.

In FIG. 4 a cross-sectional view of a heat delivering element 16 of the shaving razor system 10 taken along line A-A of FIG. 3 is shown. The heat delivering element 16 comprises a skin contacting member 225 with a skin contacting surface 106 and a lower or second surface 220 opposed to the skin contacting surface 106. A heat generator 222 is positioned below the second surface 220 of the skin contacting member 225. The heat generator 222 may comprise a resistive member 224 and an insulating member 226. The resistive member 224 has a first surface 228 and an opposed second surface 230. The insulating member 226 may have a first surface 232 and an opposed second surface 234. The first surface 232 of the insulating member 226 is joined to the second surface 220 of the heat delivering element 16. The second surface 234 of the insulating member 226 is joined to the first surface 228 of the resistive member 224.

The heat generator 222 may comprise a second insulating member 236. The second insulating member 236 may have a first surface 238 and an opposed second surface 240. The first surface 238 of the second insulating member 236 may be joined to the second surface 230 of the resistive member 224.

The resistive member 224 may have a first end 250 and an opposed second end 251. Electrical contacts 252, 253 may be provided at each end and, respectively, to the resistive member 224. The electrical contacts may comprise silver. Other conductive materials such as aluminum, copper, gold, steel, brass, nickel, and alloys thereof may be used for electrical contacts. Current leads 254, 256 are secured to electrical contacts 252, 253, respectively, to form part of an electrical circuit which is configured to deliver energy to the resistive member 224 to heat the resistive member 224. The resistive member 224 of heat generator 222 delivers heat to the heat delivering element 16 which is dissipated over the upper or skin contacting surface 106 of the heat delivering element 16 to provide warmth to the user's skin during shaving.

The insulating member 226 may be comprised of glass, glass-ceramic, ceramic, oxides, or any other dielectric materials. The resistive member 224 may be comprised of a sol-gel solution filled with a conductive powder. A coating may be formed by mixing a sol-gel solution with up to about 90% by weight of the solution of a conductive powder to provide a uniform stable dispersion. Suitable resistive members are disclosed in WO 02/072495 A2. The resistive member may also be constructed of nickel chromium, gold, steel and other materials. The resistive member preferably has a resistance of from about 0.1 to about 100 Ohm, more preferably from about 0.5 to about 20 Ohm, and most preferably 2 Ohm. The second insulating member 236 may be comprised of glass, glass-ceramic, ceramic, oxides or any other dielectric materials. The resistive member(s) may be joined to the insulating members by a sol-gel process, spraying, dipping, spinning, brushing, printing, sputtering, gluing or other suitable techniques. The resistive member 224 may heat up sufficiently to heat the skin contacting surface 106 of the heat delivering element 16 to about 30° C. to about 70° C.

To determine the heat up time that is the time required for the skin contacting surface 106 of the heat delivering element 16 to reach a certain elevated temperature above an initial temperature, a heat up method is provided that comprises of an experimental test set-up and an experimental test protocol to be executed under laboratory conditions.

Referring to FIGS. 5-8, an experimental test set-up 500 is provided in step 610 of the experimental test protocol 600 by attaching a first thermocouple 510 to the skin contacting surface 106 of the heat delivering element 16. The first thermocouple 510 should have a very small thermal mass to respond quickly to any temperature changes and not to absorb much heat from the skin contacting surface. Preferably a K-type thermocouple with Ni and NiCr wires 0.005 mm diameter is used as supplied by Omron. The first thermocouple 510 should be located in the geometrical center of the skin contacting surface 106 of the heat delivering element 16.

The first thermocouple 510 must be brought in good thermal contact with the skin contacting surface 106 of the heat delivering element 16. This can best be achieved by pressing the junction of the thermocouple 510 onto the skin contacting surface and keeping it in place by using a thermally conductive adhesive such as aluminum nitride or silver loaded epoxy resin EP30TC or EP3HTS-LO supplied by Master Bond with a thermal conductivity of at least 2.4 Watts per meter per Kelvin.

The output voltage from the first thermocouple 510 is measured and converted to degrees Celsius by a data acquisition system 530 such as National Instruments SCC-TC01 with SCC-68 and logged as a function of time with a frequency of at least 10 measurements per second and preferably with a frequency of at 50 measurements per second.

The temperature of the surrounding medium, either air or water, is measured by a second thermocouple 520. The second thermocouple 520 should be the same type as the first thermocouple 510 and logged simultaneously with the same system 530 at the same frequency as the first thermocouple 510.

In step 620 of the test protocol 600, logging of the temperature data is started. In step 630 of the experimental test protocol 600 the initial temperature of the surrounding medium and the skin contacting surface 106 of the heat delivering element 16 is measured for at least 10 seconds to establish stable initial temperatures which do not fluctuate about an average value by more than ±0.5° C.

The power source 202, such as that shown in FIG. 3B, should be provided to supply maximum available power, that is a fully charged battery in case of a rechargeable battery, or a new previously unused battery in case of a disposable battery.

In step 640 of the experimental test protocol 600, the button 208 (shown in FIGS. 1B and 3A) is pressed to activate switch 206 and turn on the electrical power to start the generation of heat in the heat delivering element 16 and to raise the temperature measured by the first thermocouple 510 on the skin contacting surface 106. The temperatures of the two thermocouples 510 and 520 are logged continuously in step 650 of the experimental test protocol 600 until the temperature measured on the skin contacting surface 106 of the heat delivering element 16 has exceeded 43° C. by at least 1° C. in step 660 of the experimental test protocol 600.

In one case shown in FIG. 5, the surrounding medium is air and should be set to a temperature between 20° C. and 22° C. While performing the experimental test method and logging the temperature data the temperature measured by the second thermocouple 520 in air should not rise by more than 1° C. above the initial air temperature.

In another case shown in FIG. 7, the surrounding medium is warm water and the distal end of the shaving razor comprising the heat delivering element 16 is immersed in a reservoir 540 containing warm water prior to logging the temperatures. The highest point 550 of the skin contacting surface 106 of the heat delivering element 16 should be immersed by at least 10 mm below the surface 555 of the water and the lowest point 560 of the skin contacting surface 106 of the heat delivering element 16 should be immersed by at least 10 mm above the bottom surface 565 of the reservoir 540. No forced convection should be created in the reservoir during the measurement.

The reservoir 540 containing water may be continuously heated during the measurement or a sufficiently big reservoir may be chosen so that the temperature of the water during the measurement is maintained between 34° C. and 36° C. While performing the experimental test method and logging the temperature data the second temperature measured by the second thermocouple 520 in the warm water should not rise by more than 1° C. above the initial water temperature.

As illustrated in FIG. 8, the heat up time 710 is the time required for the skin contacting surface 106 of the heat delivering element 16 to reach a certain elevated temperature 730 above an initial temperature 720. In step 670, this heat up time is calculated as the difference between a first time point 740 and a second time point 750 and is measured in seconds.

If the surrounding medium is air, the first time point 740 is taken when the initial temperature 720 measured on the skin contacting surface 106 of the heat delivering element 16 equals 25° C. and the second time point 750 is taken when the elevated temperature equals 43° C.

If the surrounding medium is warm water, the first time point 740 is taken when the initial temperature 720 measured on the skin contacting surface 106 of the heat delivering element 16 equals 35° C. and the second time point 750 is taken when the elevated temperature equals 43° C.

When the specified temperature values have not been logged and fall between two temperatures measured at adjacent time points, interpolation should be used to determine the time point at which the measured temperature would equal the initial or elevated temperature, respectively.

The heat delivering element 16 is able to increase the temperature of the skin contacting surface 106 from an initial temperature 720 in air of 25° C. to an elevated temperature 730 in air of 43° C. in a heat up time 710 of less than 5 seconds. This rapid heat up time in air delivers the desired user benefit with rapid heat up between shaving strokes.

In addition to heating up fast in air it is desirable if the heat delivering element is also able to heat up quickly while submerged in water. The heat delivering element 16 while submerged in water at 35° C. is able to increase the temperature of the skin contacting surface 106 from an initial temperature 720 of 35° C. to an elevated temperature 730 of 43° C. in a heat up time 710 of less than 5 seconds. This rapid heat up while submerged in water delivers a desired in-use experience for the user.

Key to the rapid heat up time 710 is providing such rapid heat up within a power range of about 4 to about 8 Watts. If the power range increases beyond 8 Watts the size of the power source becomes undesirable for everyday user use.

FIGS. 9A-9B provide an alternate schematic representation of the heat delivering element 16 focusing on the material properties for the purpose of defining properties—nominal heat up rate, R0, and nominal temperature drop, delta_T—that can provide in general the maximum calculated performance of all heat delivering elements.

Schematic representation 1000 shows a cross-sectional view of a heat delivering element and represents each component as a layer. Layer 1001 depicts an insulating layer having a thickness from about 0.5 mm to about 15 mm and a thermal conductivity below 1 W(m-K) and typically less 0.1 W/(m-K). Layers 1002, 1003, 1004, and 1005 depict thermally conducting components of the heat delivering element—components through which a large fraction of the heat is conducted that eventually reaches the skin contacting surface S3, which corresponds to the skin contacting surface 106, of the heat delivering element 16. These layers can include a heat generator 1003 such as foil heaters, resistive wire heaters, resistive layers, and ceramic heaters. These components can also include substrates and heat spreaders 1002 such ceramics, graphite foils, and layers of highly thermally conductive metals such as aluminum or copper. Such substrates and heat spreaders are depicted in the cross-sectional view by 1002 and 1005. These layers can also include the relatively thin thermal and mechanical interfaces 1004 between components such as glue or thermally conductive paste. The skin contacting surface S3 of the heat delivering element being in contact with the skin 1006 is shown to have an area A. Also shown are insulation boundary surface S1 that is at the interface of an insulation layer and the conducting components and heater element top surface boundary S2 that is a surface far from the heat generator relative to the skin contacting surface S3.

Schematic representation 1100 shows the cross-sectional of a heat delivering element that does not have an insulating layer and defines a top surface S4 as the furthest surface of the heat delivering element components from the skin contacting surface S1.

In the equations below it is assumed that each component is made from a single material having uniform thermal properties such as aluminum, stainless steel, graphite foil, and epoxy and a uniform thickness. The schematic also shows only four conducting components all of which are connected in series with each other. The equations outlined below can also be applied to heat delivering elements made from fewer or more components, heat delivering elements with components that have non-uniform thicknesses, heat delivering elements without an insulating layer, heat delivering elements with components connected in parallel, and heat delivering elements made with materials of non-uniform properties. In general, these equations can be applied to the volume of components between the skin contacting surface S3 and the insulating surface S1, the volume of components between the skin contacting surface S3 and the far heating element surface S2, and the volume of components between the skin contacting surface S3 and the furthest surface S4 of the heat delivering element from the skin contacting surface S3 for which the thermal properties can be averaged.

To determine the properties of the heat delivering element the following definitions are used:
1. Power applied to the heat delivering element: this is the maximum power input to the heat delivering element. It is assigned the symbol, Q.
2. Nominal temperature of the heat delivering element: T1.
3. Nominal temperature at interface of the conducting elements and the insulating elements on surface, S1: T2
4. Nominal temperature of heat delivering element at its skin contacting surface, S3: T3
5. Area of skin contacting member of heat delivering element on surface S3: A
6. Volumes of each layer of the N layers of the heat delivering element: V1, V2, V3, . . . . VN
7. Thicknesses of each layer of the N layers of the heat delivering element (in the Y direction of FIG. 9): t1, t2, t3, . . . tN
8. Thermal conductivity of each layer of the N layers of the heat delivering element: k1, k2, k3, . . . kN.
9. Heat capacity of each layer of the N layers of the heat delivering element: C1, C2, C3, . . . CN.
10. Density of each layer of the N layers of the heat delivering element: Rho1, Rho2, Rho3, . . . RhoN.

| | | | Thermal | Heat | |
|---|---|---|---|---|---|
| | Volume | Thickness | conductivity | Capacity | Density |
| | cm³ | Cm | W/cm-° c. | J/g-° C. | g/cm³ |
| Layer 1 | V1 | t1 | k1 | C1 | Rho1 |
| Layer 2 | V2 | t2 | k2 | C2 | Rho2 |
| Layer 3 | V3 | t3 | k3 | C3 | Rho3 |
| . | . | . | . | . | . |
| . | . | . | . | . | . |
| . | . | . | . | . | . |
| Layer N | VN | tN | kN | CN | Rho4 |

The total thermal mass between surfaces or across layers of the heat delivering element is TM. It is calculated with the following equation:

TM=Rho1*C1*V1+Rho2*C2*V2+Rho3*C3*V3+ . . . +RhoN*CN*VN

The mean thermal conductivity between surfaces or across layers of the heat delivering element is Mean_k. It is calculated with the following equation:

Mean_k=(t1+t2+t3+ . . . +tN)/(t1/k1+t2/k2+t3/k3+ . . . +tN/kN)

The layered heat up rate, RL, is the rate of temperature increase between surfaces or across layers of the heat delivering element assuming they have a uniform temperature and are being heated at the maximum power Q applied to the heat delivering element. It is calculated with the following equation:

RL=Q/TM

The layered temperature difference, Delta_T_L is the temperature drop between surfaces or across layers of the heat delivering element. It is calculated with the following equation:

Delta_T_L=Q*(t1+t2+t3+ . . . +tN)/(Mean_k*A)

The nominal heat up rate, R0, is equal to the greater of Value1 and Value2 defined below.
a. Value1:
   i. Value 1 is the layered heat up rate, RL, for layers between the skin contacting surface of the heat delivering element S3 and the insulation boundary surface S1.
   ii. If the heat delivering element does not have an insulating layer 1001 on the far side of the heating element relative to the skin, then Value1 is the layered heat up rate, RL, for layers between the skin contacting surface of the heat delivering element S3 and the top surface S4 of the heat delivering element.
b. Value2 is the layered heat up rate, RL, for layers between the skin contacting surface of the heat delivering element S3 and the far surface S2 of the heating element 1003.

The nominal temperature drop, Delta_T, is equal to the smaller of Value3 and Value4 defined below.
c. Value3:
   i. Value 3 is the layered temperature drop, Delta_T_L, for layers between the skin contacting surface of the heat delivering element S3 and the insulation boundary surface S1.
   ii. If the heat delivering element does not have an insulating layer 1001 on the far side of the heating element relative to the skin, then Value3 is the layered temperature drop, Delta_T_L, for layers between the skin contacting surface of the heat delivering element S3 and the top surface S4 of the heat delivering element.
d. Value 4 is the layered temperature drop, Delta_T_L, for layers between the skin contacting surface of the heat delivering element S3 and the far surface S2 of the heating element 1003.

Results for different razor examples are shown below. Razor examples A, C and D are representative of razors of the present invention.

| | Units | Example A | Example B | Example C | Example D |
|---|---|---|---|---|---|
| Thermal Mass | J/° C. | 0.41 | 0.58 | 0.12 | 0.15 |
| Mean Conductivity | W/cm- | 0.47 | 0.70 | 0.16 | 0.16 |
| | ° C. | | | | |
| Power | W | 5.2 | 6.5 | 6.9 | 5.4 |
| Nominal Heat Up Rate | ° C./sec | 12.6 | 11.2 | 57.4 | 35.1 |
| Heat Conducting Distance | cm | 0.125 | 0.275 | 0.04 | 0.045 |
| Heater Temperature | ° C. | 50 | 50 | 48 | 48 |
| Nominal Temperature | ° C. | 1.1 | 3.2 | 1.9 | 1.5 |
| Drop | | | | | |

Razor examples A and C and D provide excellent user benefit in terms of delivering a warming sensation during shaving and heat up time from cold start or from rinsing the razor in water. Razor example B does not provide a noticeable warming sensation while shaving and takes too long to heat up from cold start or between rinsing the razor in water.

The heat delivering element preferably has a thermal mass of from about 0.08 J/° C. to about 0.50 J/° C. The heat delivering element preferably has a mean conductivity of from about 0.10 W/cm-° C. to about 0.60 W/cm-° C. The heat delivering element may have a nominal heat rate greater than 12.0° C./second and preferably greater than about 30° C./second. The heat delivering element preferably has a nominal temperature drop of less than 2.0° C. The heat delivering element preferably has a heat conducting distance from about 0.02 cm to about 0.2 cm.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor system comprising:
a. a handle having an elongated gripping portion with a proximal end portion and a distal end portion, a heat delivering element mounted to the proximal end portion of the handle, the heat delivering element comprising a skin contacting surface, the heat delivering element is able to increase the temperature of the skin contacting surface from an initial temperature in air of 25° C. to an elevated temperature in air of 43° C. in less than 5 seconds;
b. a power source positioned within the handle, the power source is in electrical communication with the heat delivering element, the power source having a power from 4 Watts to 8 Watts;
c. a removable shaving razor cartridge mounted to the proximal end of the handle, the removable shaving razor cartridge having a housing with a guard, a cap and at least one blade mounted to the housing between the guard and the cap.

2. The shaving razor system of claim 1, wherein the heat delivering element while submerged in water at 35° C. is able to increase the temperature of the skin contacting surface from an initial temperature of 35° C. to an elevated temperature of 43° C. in less than 5 seconds.

3. The shaving razor system of claim 1, wherein the heat delivering element has a thermal mass of from 0.08 J/° C. to 0.50 J/° C.

4. The shaving razor system of claim 1, wherein the heat delivering element has a mean conductivity of from 0.10 W/cm-° C. to 0.60 W/cm-° C.

5. The shaving razor system of claim 1, wherein the heat delivering element has a nominal heat up rate greater than 12° C./second.

6. The shaving razor system of claim 1, wherein the heat delivering element has a nominal heat up rate greater than 30° C./second.

7. The shaving razor system of claim 1, wherein the heat delivering element has a nominal temperature drop of less than 2.0° C.

8. The shaving razor system of claim 1, wherein the heat delivering element has a heat conducting distance from 0.02 cm to 0.2 cm.

9. The shaving razor system of claim 1 wherein the removal shaving razor cartridge is pivotably mounted to the proximal end portion of the handle.

10. The shaving razor system of claim 1 wherein the guard comprises an elastomeric material.

11. The shaving razor system of claim 1 wherein the removable shaving razor cartridge defines an opening dimensioned to receive the heat delivering element.

12. The shaving razor system of claim 1 wherein the heat delivering element has an elongated portion extending generally parallel to the blade.

13. The shaving razor system of claim 1, wherein the heat delivering element comprises a heating element that defines a heating element top surface, one or more components between the heating element and the skin contacting surfacing, or combination thereof.
